(19) United States
(12) Patent Application Publication
(10) Pub. No.: US 2010/0043762 A1
(43) Pub. Date: Feb. 25, 2010

(54) METHOD FOR CONTROLLING THE EXHAUST GAS RECIRCULATION OF AN INTERNAL COMBUSTION ENGINE

(76) Inventors: Frank Weiss, Pentling/Grasslfing (DE); Hong Zhang, Tegernheim (DE)

Correspondence Address: King & Spalding LLP, 401 Congress Avenue, Suite 3200, Austin, TX, 78701, US

(21) Appl. No.: 12/523,905

(22) PCT Filed: Jan. 22, 2008
(86) PCT No.: PCT/EP08/50723

§ 371 Date: Jul. 21, 2009

(30) Foreign Application Priority Data
Jan. 25, 2007 (DE) 10 2007 003 855.2

(51) Int. Cl. F02B 47/08; F01L 1/34

(52) U.S. Cl. 123/568.14; 123/568.21; 123/90.15

(57) ABSTRACT

For this method, a portion of the exhaust gas is recirculated from the exhaust train via an external line to the intake manifold and is mixed with the fresh air supplied to the cylinder, and a further portion of the exhaust gas is supplied once again through the valves internally to the combustion space of the engine. The internally recirculated amount of exhaust gas is adjusted by controlling the cam phases (VVT) as a function of the engine load and engine rpm. A target value (VVT_EGR_SP) for the internal recirculation rate of the exhaust gas is calculated as the difference between the target value (EGR_SP) of the recirculation of the exhaust gas and the external recirculation rate of the exhaust gas (EXT_EGR_RATE).

### CROSS-REFERENCE TO RELATED APPLICATIONS

This application is a U.S. National Stage Application of International Application No. PCT/EP2008/050723 filed Jan. 22, 2008, which designates the United States of America, and claims priority to German Application No. 10 2007 003 855.2 filed Jan. 25, 2007, the contents of which are hereby incorporated by reference in their entirety.

### TECHNICAL FIELD

The invention relates to a method to control the exhaust gas recirculation of an internal combustion engine, in which part of the exhaust gas is recirculated from the exhaust train via an external line to the intake manifold and is mixed with the fresh air supplied to the cylinder and a further part of the exhaust gas is supplied once again through the valves internally to the combustion space of the engine. In this way an external and an internal exhaust gas recirculation rate (also referred to below as EGR rate) exists.

### BACKGROUND

The internal EGR rate in engines known from operational practice is fixed because the cam phase can not be adjusted.

In order to comply with increasingly stringent emission limit values for diesel or petrol engines, precise control of the combustion process is needed. To this end, a rapid and precise control of the exhaust gas recirculation rate, also referred to below as EGR rate, is an important requirement. Difficulties arise in the case of known exhaust gas recirculation systems, in which the exhaust gas is recirculated from the exhaust train via an external line to the intake manifold (see for instance Fachkunde Kraftfahrzeugtechnologie [Automotive Engineering Studies], published by Europa-Lehrmittel, 26^{th} Edition, page 311).

During the engine warm-up, hot recirculated exhaust gas is needed for faultless combustion, this can however not be achieved to an adequate degree with an external exhaust gas recirculation system because the exhaust gas cools down significantly when traveling from the exhaust train to the intake manifold. To achieve a high EGR rate, a partially throttled operation must ensue which nevertheless increases consumption. Only minimal dynamics of the EGR rate can thus be achieved.

### SUMMARY

According to various embodiments, a method for controlling the exhaust gas recirculation in an internal combustion engine can be created, which improves the dynamics of the exhaust gas recirculation. Faultless combustion should also be ensured during the engine warm-up, by the mixed temperature being increased.

According to an embodiment, a method for controlling the exhaust gas recirculation of an internal combustion engine, in which part of the exhaust gas is recirculated from the exhaust train via an external line to the intake manifold and is mixed with the fresh air supplied to the cylinder and a further part of the exhaust gas is supplied once again through the valves internally to the combustion space of the engine, may comprise the step of setting the internally recirculated quantity of exhaust gas by controlling the cam phases as a function of the engine load and the engine rpm.

According to a further embodiment, a target value for the internal exhaust gas recirculation rate with cam phase controller can be calculated as the difference between the target value of the exhaust gas recirculation and the external exhaust gas recirculation rate. According to a further embodiment, the external exhaust gas recirculation rate and the internal exhaust gas recirculation rate may be determined as a function of the engine load, the rpm, the current position of the cam shaft, of the intake manifold and of the exhaust gas pressure. According to a further embodiment, a target value for the exhaust gas recirculation may be determined as a function of the engine load and the rpm and a target value for the external exhaust gas recirculation is determined as a function of the engine load and the rpm. According to a further embodiment, a regulator for the external exhaust gas recirculation may generate a pulse width modulation value to control the external exhaust gas recirculation. According to a further embodiment, a regulator for the internal exhaust gas recirculation may generate a pulse width modulation value in order to control the internal cam phase-controlled exhaust gas recirculation.

### BRIEF DESCRIPTION OF THE DRAWINGS

Exemplary embodiments are described below with reference to the drawing, in which;

FIG. 1 shows a diagram for explaining the method according to an embodiment and

FIG. 2 shows a flow chart of the program processed in the method according to an embodiment.

### DETAILED DESCRIPTION

With the method according to various embodiments, the internally recirculated exhaust gas quantity can be adjusted by controlling the cam phases as a function of the engine load and the engine rpm. Different cam phases result in different quantities of fresh air and recirculated exhaust gas in the cylinder. The advantage here is that the combusted gas does not have to be routed from the outlet via a line to the inlet of the engine. With the method according to various embodiments, referred to below as VVT system, the combusted gas is directly available again for the next combustion. The VVT system is also superior to known systems with external exhaust gas recirculation in respect of the adjustment accuracy of the EGR rate.

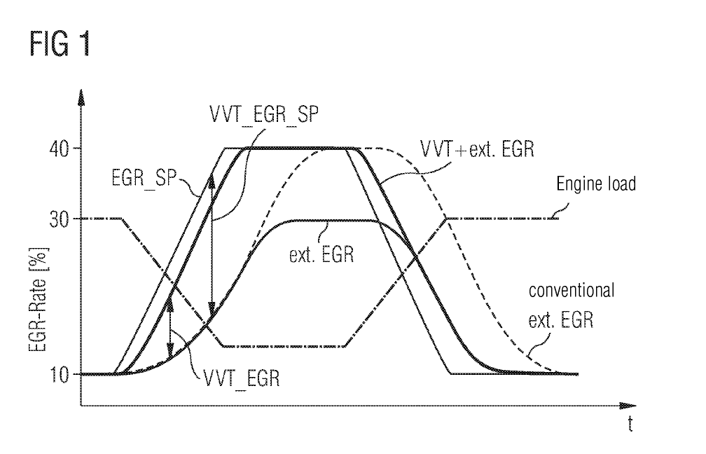

FIG. 1 shows different temporal curves of EGR rates. In the diagram which is apparent in FIG. 1, the curve of the engine load and subsequent variables and status parameters of the engine are shown as a function of the time.

| | |
|---|---|
| Exhaust gas recirculation rate | EGR_SP |
| Internal exhaust gas recirculation rate target value | VVT_EGR_SP |
| Internal exhaust gas recirculation rate | VVT_EGR |
| External exhaust gas recirculation rate | ext. EGR |
| Known external exhaust gas recirculation | conventional |
| | ext. EGR |
| Total internal and external exhaust gas recirculation | VVT + ext.EGR |
| rate | |

Engine Load

The engine load is determined by the driver input, in other words it corresponds to the activity of the accelerator by the driver.

The internal EGR rate VVT_EGR is composed of two sub quantities. The one quantity is expelled and immediately taken in again via the outlet valve. The other sub quantity is initially not expelled. Both sub quantities can be adjusted with a variable cam shaft.

The internal exhaust gas recirculation rate VVT_EGR is achieved by means of an cam phase controller VVT (variable valve timing) according to various embodiments, in other words by means of a targeted adjustment of the cam shaft. Different cam phases result in different quantities of fresh air and EGR in the cylinder. The gas combusted in the engine does not need to be routed from the outlet via a line to the inlet of the engine. With a VVT system, the combusted gas is directly available again for the next combustion.

An optimal EGR rate exists for each rpm or load point of the engine. This is usually set to be stationary by means of the external EGR system. During a dynamic operation of the engine, it is claimed that the EGR rate has to be adjusted with the same dynamics as the rpm or load point so as to ensure faultless operation. This is therefore not possible with an external EGR system because the service life is significantly greater than the engine dynamics. With the VVT system however, the change in speed of the exhaust gas recirculation rate EGR_Rate depends solely on the change in speed of the cam phase controller, and this provides adequate dynamics for the majority of driving situations.

This is achieved by the difference between the EGR target value and the exhaust gas recirculation rate of the external EGR system being provided by the VVT system (arrow VVT_EGR in FIG. 1). The setup of the exhaust gas recirculation is as a result significantly accelerated, as is apparent from FIG. 1: the increase in the exhaust gas recirculation (drawn-through stronger line “VVT+ext. EGR”) according to various embodiments takes place earlier than the increase in the known exhaust gas recirculation (dashed line “conventional ext. EGR”). In order also to be able to rapidly illustrate the EGR reduction accordingly, a part of the EGR rate must also be provided in a stationary fashion by the VVT system. The delayed reaction time of the external EGR system can thus be compensated for by controlling the VVT system. This means that an individual target value has to be determined for the external EGR system, said target value being less than the EGR target value of the engine. The target value for the VVT system then results from the difference between the EGR target value of the engine and the external EGR rate. This difference is clarified by the arrow VVT_EGR_SP in FIG. 1.

During the engine warm-up, a high mixed temperature is advantageous. As a result, the mixture formation is improved and the harmful exhaust gas emissions reduce correspondingly. The external EGR system is disadvantageous here in that the exhaust gas is cooled during the recirculation. There is no cooling effect with the VVT system. An individual target value for the external EGR system is thus defined for the warm-up phase. This is lower than the target value of the operationally warm engine, in one example the EGR rate lies at a value of 30% and the exhaust gas recirculation rate of the VVT system increases as a result. With the previous or conventional system, a bypass around the EGR cooler is used during warmup in order to achieve the highest possible exhaust gas recirculation temperature. Such a bypass can be dispensed with in the case of the VVT system.

During operation with an exclusively external EGR system, the fresh air supply has to be throttled in order to achieve high EGR rates. This throttling increases the exhaust gas recirculation rate and reduces the fresh air rate, but nevertheless also results in a higher fuel consumption. This throttling is no longer or only marginally required with the VVT method. To control the VVT system, an individual target value is defined for the external EGR system, which is less than the standard target value. A higher EGR rate is thus set, thereby also resulting in the desired exhaust gas recirculation rate without or with an only marginal throttling.

The improved dynamics in the setup of the exhaust gas recirculation and the use of individual EGR target values during warm-up and during particle regeneration reduces both the fuel consumption and also the emissions. Costs for the bypass of the exhaust gas recirculation cooler are thus saved.

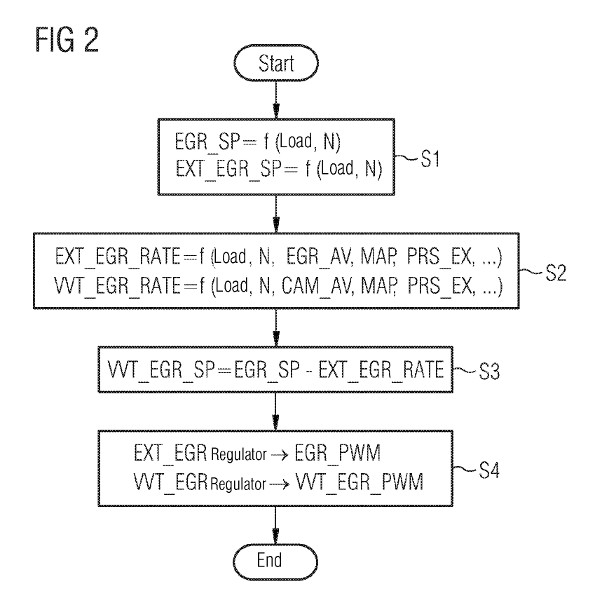

In the flow chart of a program run in the method according to various embodiments for controlling the exhaust gas recirculation in an internal combustion engine which is visible in FIG. 2, after

| | |
|---|---|
| Start | in a step |
| S1 | a target value EGR_SP for the exhaust gas |
| | recirculation is determined as a function of the |
| | engine load and the engine rpm as well as a target |
| | value EXT_EGR_SP for the external exhaust gas |
| | recirculation EGR as a function of the engine load |
| | and the engine rpm. |
| | In a step |
| S2 | an external exhaust gas recirculation rate |
| | EXT_EGR_RATE and an internal exhaust gas |
| | recirculation rate VVT_EGR_RATE are determined as a |
| | function of the engine load, the engine rpm N, the |
| | current position CAM_AV of the cam shaft, of the |
| | intake manifold pressure MAP, of the exhaust gas |
| | counter pressure PRS_EX, and if necessary further |
| | operating variables. In a step |
| S3 | a target value VVT_EGR_RATE is calculated for the |
| | internal exhaust gas recirculation rate (with |
| | changeable cam phase controller) as a difference |
| | between the target value EGR_SP and the external |
| | exhaust gas recirculation rate EXT_EGR_RATE. |
| | In a step |
| S4 | an EXT-EGR-regulator for the external exhaust gas |
| | recirculation generates a pulse width modulation |
| | value EGR_PWM for the external exhaust gas |
| | recirculation EGR and a VVT_EGR-regulator for the |
| | internal exhaust gas recirculation generates a pulse |
| | width modulation value VVT_EGR_PWM for the internal |
| | (in other words the cam phase controlled) exhaust |
| | gas recirculation. The program is thus at the |
| End | |

The program is processed continuously.

The numerical values of the operational and state variables used during the previously described computational steps depend on the particular engine type. They are determined empirically in the configuration of the engine and are stored in the form of characteristic curves in the engine timing.

What is claimed is:

1. A method for controlling the exhaust gas recirculation of an internal combustion engine, in which part of the exhaust gas is recirculated from exhaust train via an external line to an intake manifold and is mixed with fresh air supplied to a cylinder and a further part of the exhaust gas is supplied once again through valves internally to a combustion space of the engine,
the method comprising the step of:
setting the internally recirculated quantity of exhaust gas by controlling cam phases as a function of an engine load and engine rpm.

2. The method according to claim 1, wherein a target value for the internal exhaust gas recirculation rate with cam phase controller is calculated as the difference between the target value of the exhaust gas recirculation and the external exhaust gas recirculation rate.

3. The method according to claim 2, wherein the external exhaust gas recirculation rate and the internal exhaust gas recirculation rate are determined as a function of the engine load, the rpm, the current position of the cam shaft, of the intake manifold and of the exhaust gas pressure.

4. The method according to claim 1, wherein a target value for the exhaust gas recirculation is determined as a function of the engine load and the rpm and a target value for the external exhaust gas recirculation is determined as a function of the engine load and the rpm.

5. The method according to claim 1, wherein a regulator for the external exhaust gas recirculation generates a pulse width modulation value to control the external exhaust gas recirculation.

6. The method according to claim 1, wherein a regulator for the internal exhaust gas recirculation generates a pulse width modulation value in order to control the internal cam phase-controlled exhaust gas recirculation.

7. A system for controlling the exhaust gas recirculation of an internal combustion engine, comprising an exhaust train from which part of the exhaust gas is recirculated via an external line to an intake manifold and is mixed with the fresh air supplied to a cylinder and a further part of the exhaust gas is supplied once again through valves internally to a combustion space of the engine,
and further comprising control means operable to set the internally recirculated quantity of exhaust gas by controlling cam phases as a function of an engine load and engine rpm.

8. The system according to claim 7, wherein a target value for the internal exhaust gas recirculation rate with cam phase controller is calculated as the difference between the target value of the exhaust gas recirculation and the external exhaust gas recirculation rate.

9. The system according to claim 8, wherein the external exhaust gas recirculation rate and the internal exhaust gas recirculation rate are determined as a function of the engine load, the rpm, the current position of the cam shaft, of the intake manifold and of the exhaust gas pressure.

10. The system according to claim 7, wherein a target value for the exhaust gas recirculation is determined as a function of the engine load and the rpm and a target value for the external exhaust gas recirculation is determined as a function of the engine load and the rpm.

11. The system according to claim 7, wherein a regulator for the external exhaust gas recirculation generates a pulse width modulation value to control the external exhaust gas recirculation.

12. The system according to claim 7, wherein a regulator for the internal exhaust gas recirculation generates a pulse width modulation value in order to control the internal cam phase-controlled exhaust gas recirculation.
